(19) United States
(12) Patent Application Publication
(10) Pub. No.: US 2019/0075623 A1
(43) Pub. Date: Mar. 7, 2019

(54) ARC SHAPED HEATING COILS

(71) Applicant: Hydra Heating Industries, LLC, Atlanta, GA (US)

(72) Inventors: Michael Hoffman, Foley, AL (US); James Meigs, Mobile, AL (US)

(21) Appl. No.: 15/695,230

(22) Filed: Sep. 5, 2017

(51) Int. Cl. H05B 6/36; H05B 6/10; H05B 6/44; H05B 3/42

(52) U.S. Cl. CPC H05B 6/36; H05B 3/42; H05B 6/44; H05B 6/108

(57) ABSTRACT

Aspects and embodiments of systems inductive heating using arc-shaped heating coils are described. Arc-shaped conductors of a heating coil are curved with a radius of curvature. Respective arc-shaped conductors have a shape of an arc having the radius of curvature. Each respective arc-shaped conductor of the plurality of arc-shaped conductors are arranged orthogonal to the radius of curvature.

### BACKGROUND

Viscous fluids such as waste oil can include a combination of hydrocarbons, oils, gasses, water, other liquids and solids obtained naturally or as a residue from processing. Other viscous fluids such as tar sands include a combination of clay, sand, water, and bitumen, which is a black viscous mixture of hydrocarbons obtained naturally or as a residue from petroleum distillation. Tar sands can be mined and processed to extract the oil-rich bitumen, and the bitumen can be refined into oil. The recovery of oil from the bitumen in tar sands requires extraction and separation systems to separate the bitumen from the clay, sand, and water that make up the tar sands. Because these fluids and other base materials are so viscous, they can be difficult to process and transport using pipelines and tank cars.

### BRIEF DESCRIPTION OF THE DRAWINGS

Aspects of the present disclosure can be better understood with reference to the following drawings. It is noted that the elements in the drawings are not necessarily to scale, with emphasis instead being placed upon clearly illustrating the principles of the embodiments. In the drawings, like reference numerals designate like or corresponding, but not necessarily the same, elements throughout the several views.

FIG. 1A is a drawing that illustrates a perspective view of a heating structure that includes arc-shaped heating assemblies according to an embodiment of the present disclosure.

FIG. 1B is a drawing that illustrates a perspective view of an arc-shaped heating assembly according to an embodiment of the present disclosure.

FIG. 2 is a drawing that illustrates a perspective view of another arc-shaped heating assembly according to an embodiment of the present disclosure.

FIG. 3A is a drawing that illustrates a serpentine heating coil according to an embodiment of the present disclosure.

FIG. 3B is a drawing that illustrates arc-shaped heating coils according to an embodiment of the present disclosure.

FIG. 4 is a drawing that illustrates a spiral heating coil according to an embodiment of the present disclosure.

FIG. 5 is a drawing that illustrates an example an arc-shaped heating coil and a rail truck.

### DETAILED DESCRIPTION

As noted above, some fluids can be very viscous, and can be difficult to process and transport. These fluids can include tar sands, bitumen, waste oils, waste plastics, and other viscous fluids. The present disclosure describes systems and methods for heating using arc-shaped heating coils, including hinged arc-shaped heating coils. Arc-shaped heating coils can be utilized to heat tubes, pipes, tanks, and any conductive object.

In some cases, the systems and methods described can help heating, processing, and transportation of fluids within pipes and transportation tanks. Transportation pipes such as those used in pipelines and other piping applications can include various types of metals including steel and other appropriate metals. Grades of steel vary in chemical composition and can include carbon manganese, multi-element and micro-alloyed compositions having various material specifications and pipe grades. Transportations pipes can meet ASTM specifications, API 5L specifications, CSA Z245.1 specifications, schedule 80 steel pipe, and other specifications to match the application. Accordingly, many such transportation pipes can be inductively heated or resistively heated. Such transportation pipes can be used to transport fluids including liquid and/or gaseous substances as well as those mixed with solids.

Truck trailer tanks, rail tank cars, and tank wagons are types of transportation tanks that can also be designed to transport fluids including liquid and/or gaseous substances as well as those mixed with solids. The U.S. DOT-111 and DOT-117, DOT-117/R are examples of transportation tanks used in North America. As an example, transportation tanks built to the DOT-117 specification can be circular in cross section, having a minimum plate thickness of 916 inch and a maximum capacity of 34,500 US gallons. Heat shields should be ½ inch. Transportation tanks built to the U.S. DOT-117 specification can be constructed from carbon steel, aluminum alloy, high alloy steel, nickel plate steel, or another suitable material by fusion welding. Accordingly, many such transportation tanks can be inductively heated or resistively heated.

Because of the variety of different types of liquids and gases that can be transported in transportation tanks, different types of transportation tanks can be pressurized or non-pressurized, insulated or non-insulated, and designed for carrying one or several different types of substances. Depending upon the type of substance it is designed to transport, the interior of a transportation tank can be lined with glass or another suitable coating to isolate the contents of the tank from the shell of the tank. Transportation tanks carrying dangerous goods are generally made of different types of steel, depending on the intended cargo and operating pressure. Such transportation tanks can also be lined with rubber or coated with specialized coatings for the protection of the tank or to protect the purity of the product being transported. In some cases, these linings and surroundings can be used for transportation pipes as well. According to aspects of the embodiments, transportation tanks, pipes, and any conductive objects can be heated using electromagnetic induction or resistive heating.

Heating coils can be used to heat objects like transportation tanks and pipes and their contents. These heating coils can include inductive heating coils and resistive heating coils. For example, an electrically conducting object (e.g., a metal) can be heated by electromagnetic fields using electromagnetic induction. In electromagnetic induction, an electrically conducting object is heated by eddy currents induced in it by electromagnetic induction. As one example of the process of induction or inductive heating, alternating current (AC) can be passed through a wire or coil (i.e., inductive coil) positioned closely to or wrapped around an electrically conducting object. An alternating magnetic field is then generated around an inductive coil, which penetrates the electrically conducting object. High-frequency alternating magnetic fields (e.g., around 100-500 kHz or greater) can cause electric currents, called eddy currents, to be generated inside the electrically conducting object. The eddy currents heat the electrically conducting object by the magnetic resistance inherent in the heated object. Lower frequencies such as line or utility frequencies (e.g., 50, 60, 140, 400 Hz) can be used to alternate the magnetic field and cause heating through electric currents inside the electrically conducting object.

For ferrous metals like iron and some types of steel, an additional heating mechanism beyond eddy currents occurs. Particularly, the alternating magnetic field inside the coil repeatedly magnetizes and de-magnetizes iron crystals in the electrically conducting object. This flipping of the magnetic domains causes considerable friction and heating inside the object. Heating due to this mechanism is known as hysteresis loss and is greater for materials having a large area inside their magnetic flux density (B)/magnetic field strength (H) curve. Hysteresis loss can be a large contributing factor to heat generated through induction.

Using inductive coils and inductive heating, an electrically conducting object can be directly and rapidly heated without using thermal conduction. Because thermal conduction is not relied upon, there is no need to make contact with the object being heated, but in some cases the coil can make such contact. Inductive heating is used in many industrial processes, such as heat treatment in metallurgy, crystal growth in the semiconductor industry, and to melt refractory metals which require very high temperatures. Inductive heating is also used in certain cooktops for cooking.

A heating coil can also include resistive coils. A coil can be heated by resistive heating or Joule heating. For example, in resistive heating, an electrically conducting coil is heated by causing electrical currents to flow through the coil. In resistive heating, the power of heating is proportional to I²×R, where I is the current through the coil and R is the resistance of the coil. Since the coil itself is heated in resistive heating using resistive coils, it can be beneficial to have the coil close, or in contact with, an object to be heated in order to increase thermal conduction. Any of the heating coils discussed (e.g., inductive, resistive) can be hollow heating coils, solid heating coils, or another type of cross-section.

In the context outlined above, aspects and embodiments of systems and methods for heating with arc-shaped heating coils are described. For example, over the road tanks, rail tank cars and other transportation tanks are difficult to encircle with coils or other devices. The bolster or tank cradle components can get in the way. In some of the various embodiments, a partial circling can be achieved with removable or permanent coils. Embodiments allow, for example, rail tank cars to pull into a spot and be heated via the overhead dropping of claw like coils. This can be an efficient use of space and can add to the capabilities of transloaders for any transportation tank, transportation pipe, and other objects.

In some embodiments, an apparatus can include a first arc-shaped heating coil having a radius of curvature. The first arc-shaped heating coil can be electrically connected to a power source. Additional circuitry can be used to cause current to flow within the heating coil for resistive heating, or cause an alternating current to flow within the heating coil for inductive heating. A second arc-shaped heating coil can have a same radius of curvature as the radius of curvature of the first arc-shaped heating coil and can also be electrically connected to the power source, and in some cases additional circuitry. A hinge can be attached to the first arc-shaped heating coil and to the second arc-shaped heating coil. An articulation assembly can be connected to the first arc-shaped heating coil, the second arc-shaped heating coil, and the hinge. The articulation assembly can rotate the first arc-shaped heating coil and the second arc-shaped heating coil at the hinge to form a major arc, for example, the major arc of a circle having the radius of curvature of the first arc-shaped heating coil and the second arc-shaped heating coil. This can cause the device to partially surround and hold to an object like a transportation tank on a tank car, without interfering with the bolster, cradle, other supports or other objects towards the bottom of the tank car. Other objects like transportation pipes can also be partially surrounded by the device. In some situations, the articulation assembly can be detachably connected to the first arc-shaped heating coil, the second arc-shaped heating coil, and the hinge. This can allow for semi-permanent attachment to the object to be heated. In the case of a transportation tank, the tank can be moved away from the articulation assembly and the tank can be heated in another location, for example, to introduce or remove fluids from the tank.

In some examples, the first arc-shaped heating coil and the second arc-shaped heating coil are inductive heating coils that produce an alternating magnetic field for inductive heating. In other examples, the first arc-shaped heating coil and the second arc-shaped heating coil are resistive heating coils.

In some examples, the first arc-shaped heating coil is a serpentine heating coil comprising a plurality of arc-shaped sections that extend and curve with the radius of curvature and are parallel to one another laterally, orthogonal to the radius of curvature. In other examples, another arrangement can be used, wherein the first arc-shaped heating coil is a serpentine heating coil comprising a plurality of straight sections that are arranged along a curve with the radius of curvature and extend laterally, orthogonal to the radius of curvature. The first arc-shaped heating coil can also be a spiral heating coil that is curved with the radius of curvature.

In further embodiments, a heating coil can include a plurality of arc-shaped conductors or coil sections that are curved with a radius of curvature. A respective arc-shaped conductor of the plurality of arc-shaped conductors can be a major arc of a circle having the radius of curvature. Each respective arc-shaped conductor of the plurality of arc-shaped conductors being arranged laterally parallel and orthogonal to the radius of curvature. The plurality of arc-shaped conductors can be connected in a single pattern of the heating coil, which can be a spiral pattern, a serpentine pattern, or another pattern. The major arc of each respective arc-shaped conductor of the plurality of arc-shaped conductors is partially surrounding an object to be heated.

In other situations, the respective arc-shaped conductor of the plurality of arc-shaped conductors can instead be a minor arc of a circle having the radius of curvature. The heating coil can be manipulated, placed, or bent partially surrounding a transportation tank, a transportation pipe, or any other object. The plurality of arc-shaped conductors can be arranged laterally, orthogonal to the radius of curvature.

In some examples, the heating coil is an inductive heating coil that produces an alternating magnetic field for inductive heating. In other examples, the heating coil is a resistive heating coil.

In some examples, the heating coil is a serpentine heating coil, and the respective arc-shaped conductor of the plurality of arc-shaped conductors is electrically connected to an adjacent arc-shaped conductor of the plurality of arc-shaped conductors in a serpentine pattern. In other examples, the heating coil is a spiral heating coil, and the plurality of arc-shaped conductors is electrically connected in a spiral pattern.

In additional embodiments, an apparatus can include a first arc-shaped heating coil having a radius of curvature. The first arc-shaped heating coil can include a first plurality of arc-shaped conductors that are curved with the radius of curvature. A respective arc-shaped conductor of the first plurality of arc-shaped conductors can have a shape of a first minor arc of a circle having the radius of curvature. The first arc-shaped heating coil can be electrically connected to a power source. The apparatus can also include a second arc-shaped heating coil having the radius of curvature. The second arc-shaped heating coil can include a second plurality of arc-shaped conductors that are curved with the radius of curvature. A respective arc-shaped conductor of the second plurality of arc-shaped conductors can have a shape of a second minor arc of a circle having the radius of curvature. The second arc-shaped heating coil can be electrically connected to the power source. A connector can be attached to the first arc-shaped heating coil and to the second arc-shaped heating coil, and can align the first arc-shaped heating coil and to the second arc-shaped heating coil into a single arc shape. In some examples, the single arc shape is a major arc of the circle having the radius of curvature. Additional articulation is feasible and when required, can be used to encompass tanks that have some oblique characteristics, like an oval shaped tank, with the same structure. Alternatively, instead of having a radius of curvature, each coil can have a shape that is designed to fit around a particular shape of an object, and the hinge allows the coils to open and close about the particular shape of the object.

In some examples, the connector can be a hinged connector that allows the first arch-shaped heating coil and the second arc-shaped heating coil to rotate with respect to one another as well as form the single arc shape. The connector can lock in place to form the single arc shape. In other examples, the connector can be a rigid connector that does not include a hinge. The connector can, in some cases, include a plurality of tubes that accept the first plurality of arc-shaped conductors and the second plurality of arc-shaped conductors, for example, by inserting the respective arc-shaped conductor of the first plurality of arc-shaped conductors and the respective arc-shaped conductor of the second plurality of arc-shaped conductors into the tubes of the connector.

In some examples, the respective arc-shaped conductor of the first plurality of arc-shaped conductors is electrically connected to an adjacent arc-shaped conductor of the first plurality of arc-shaped conductors to form a serpentine pattern circuit. In other examples, the first plurality of arc-shaped conductors is electrically connected to form a spiral pattern circuit. The respective arc-shaped conductor of the second plurality of arc-shaped conductors can also form either a serpentine or a spiral pattern circuit.

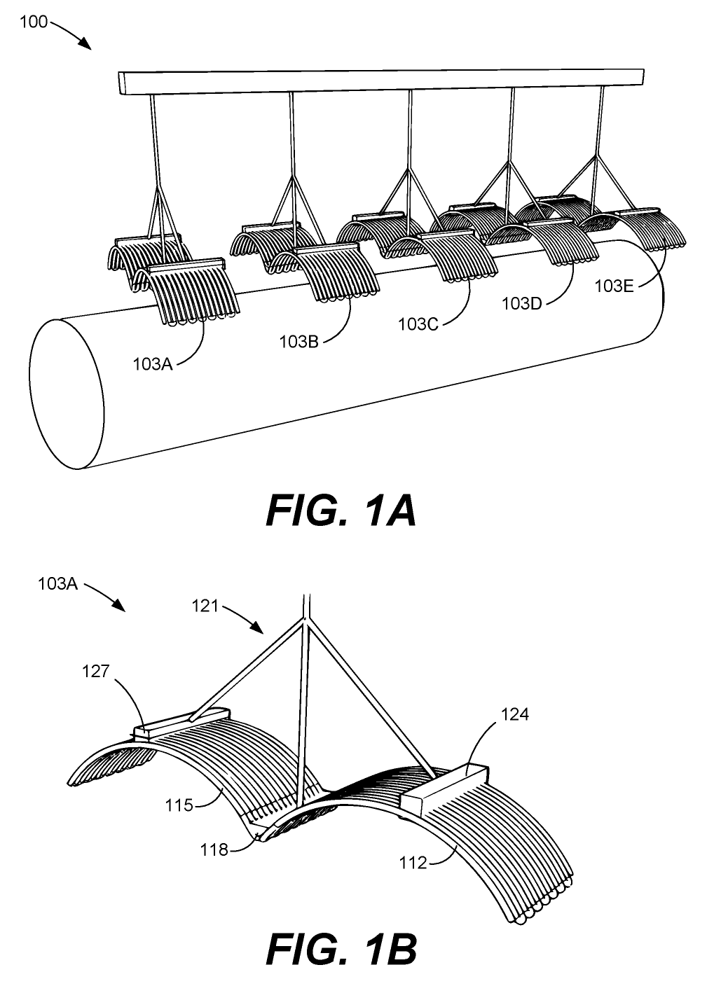

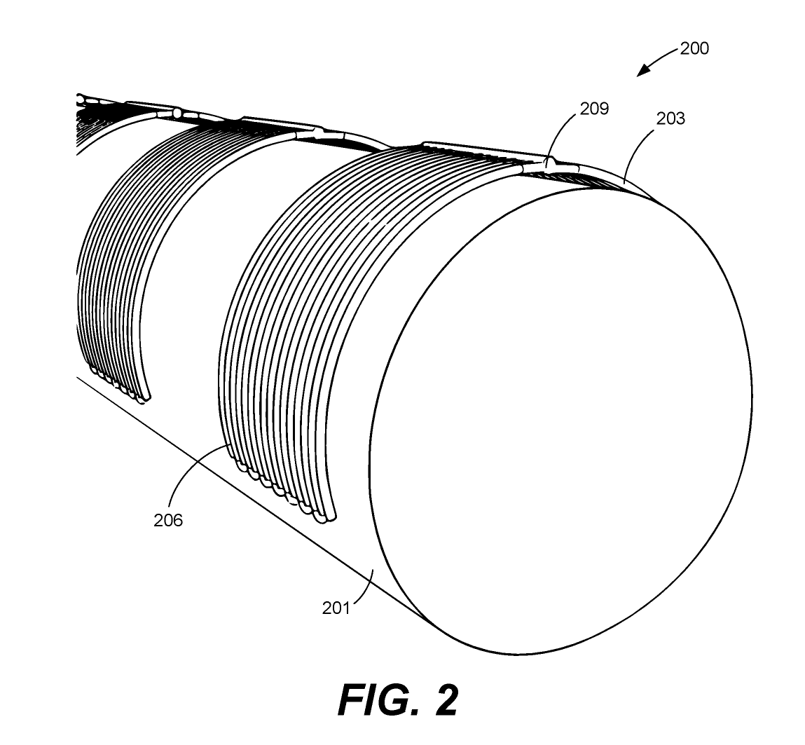

Moving now to the figures, FIG. 1A illustrates a heating structure 100. The heating structure 100 can include a suspension element like a rail, beam, or arm that suspends a plurality of arc-shaped heating assemblies 103A-103E. Each of the arc-shaped heating assemblies 103A-103E can be suspended using a respective suspension or articulation assembly that can utilize cable-based components, rigid components, or a combination of cables and rigid components. The articulation assembly can also articulate the arc-shaped heating assemblies 103A-103E to clasp or partially surround an object for heating. In some cases, the heating structure 100 can be used as part of a transloader or can be used in conjunction with a transloader, like a trailer-based transloader or a permanent facility for loading and unloading transportation tanks. The arc-shaped heating assemblies 103A-103E of the heating structure 100 can also be used for heating pipes or any other object.

In some cases, the heating structure 100 can be used to lift and lower the arc-shaped heating assemblies 103A-103E. The heating structure 100 can also open and close the arc-shaped heating assemblies 103A-103E around a pipe, a tank car, transportation pipe, transportation tank, or other object. In some cases, the claw- or clam-like arrangement can fold or pivot about a hinge where the center part extends, retracts, or remains stable relative to the arc-shaped heating coils of the arc-shaped heating assemblies 103A-103E, as the arc-shaped heating assemblies 103A-103E are lowered into place.

The heating structure 100 can include electrical connections to a power supply (not shown) that connects to the arc-shaped heating assemblies 103A-103E and provides electrical power to pass current through each of the arc-shaped heating assemblies 103A-103E. Where the arc-shaped heating assemblies 103A-103E utilize inductive heating, AC power can be passed through inductive coils of the arc-shaped heating assemblies 103A-103E to generate a magnetic field around each inductive coil. This magnetic field can penetrate an electrically conducting object to heat the object using eddy currents and other effects.

In some cases, an electrical circuit or control circuit that is in electrical connection with the power source and the heating coils can be used to control the current flow through the heating coil. An inductive control circuit can cause AC current to flow through the heating coils to cause a magnetic field (e.g., an alternating magnetic field) to be produced by the heating coils in order to apply inductive heating to an object. A resistive control circuit can cause the heating coils to themselves be heated using AC or direct current (DC), and heat can be transferred to the object through conductive and radiant thermal transfer. Meters like hall effect sensors, ammeters, voltmeters, and thermocouples can monitor magnetic fields, currents, and voltages, and temperatures.

A controller of the control circuit can adjust circuit components including variable resistances, reactances, capacitances, inductances, and the like. Using the meters (e.g., using the thermocouples or another measuring device), the controller can measure a temperature of the heating coils and control the heating coils (e.g., inductive coils or resistive coils) to maintain the temperature below (or above) a predefined threshold temperature or at a particular temperature or within a particular temperature range. The control circuit can measure the temperature of each of the heating coils in the system independently, and can adjust power or other circuit components in order to individually control each of the heating coils in the system. In some cases, temperature sensors can also measure temperature of the object to be heated (e.g., a transportation tank or pipe) and further control the heating coils to maintain the object's temperature below (or above) a predefined threshold temperature or at a particular temperature or within a particular temperature range.

Moving to FIG. 1B, shown is an example of the arc-shaped heating assembly 103A, which can be representative of any of the arc-shaped heating assemblies 103A-103E. The arc-shaped heating assembly 103A can include an arc-shaped heating coil 112 and an arc-shaped heating coil 115, each of which is connected to a hinge 118. An articulation assembly 121 can be attached to the arc-shaped heating coil 112 and the arc-shaped heating coil 115, as well as to the hinge 118. In some cases, the articulation assembly 121 can be attached to the arc-shaped heating coil 112 using a bar 124 that extends laterally across the conductors of the arc-shaped heating coil 112. The articulation assembly 121 can be attached to the arc-shaped heating coil 115 using a bar 127 that extends laterally across the conductors of the arc-shaped heating coil 115.

The arc-shaped heating coil 112 can have a radius of curvature, or substantially continuous or uniform curve. The arc-shaped heating coil 112 can include a number of arc-shaped conductors that are curved with the radius of curvature. A respective arc-shaped conductor of the arc-shaped heating coil 112 can have a shape of a first minor arc of a circle having the same radius of curvature. That is, the arc-shaped heating coil 112 can have a cross section or side view in the form of an arc that is less than half of the circle having the radius of curvature.

The arc-shaped heating coil 115 can also have a substantially continuous or uniform curve. In some examples, a radius of curvature of the arc-shaped heating coil 115 can be a same radius of curvature as that of the arc-shaped heating coil 112. The arc-shaped heating coil 115 can include a number of arc-shaped conductors that are curved with the radius of curvature. A respective arc-shaped conductor of the arc-shaped heating coil 115 can have a shape of a first minor arc of a circle having the same radius of curvature. That is, the arc-shaped heating coil 115 can have a cross section or side view in the form of an arc that is less than half of the circle having the radius of curvature.

As the arc-shaped heating coil 112 and the arc-shaped heating coil 115 are positioned to partially surround a pipe, tank, or other object, a portion of the pipe, tank, or other object is not surrounded or interfered with. This can be helpful where a tank car sits on a bolster plate or bowl, or the tank car includes wheels for rail or road transport, the bottom of the tank is not interfered with. Likewise, where a pipeline or other pipe is supported by such a bolster, cradle, or ground, the bottom of the pipeline is not interfered with. In some cases, a pipeline could be supported from a side or suspended from above, and as the arc-shaped heating coil 112 and the arc-shaped heating coil 115 are positioned to partially surround the pipeline, the portion from which the pipeline is supported can be avoided while still surrounding a portion of the pipeline for heating.

The hinge 118 can be attached to the arc-shaped heating coil 112 and the arc-shaped heating coil 115. The articulation assembly 121 can be connected to the arc-shaped heating coil 112, the arc-shaped heating coil 115, and the hinge 118. The articulation assembly 121 can rotate the arc-shaped heating coil 112 and the arc-shaped heating coil 115 at the hinge 118 so that they are aligned to form another, larger arc (e.g., from a side view or cross-section al view) from the two coils. In some cases, the larger arc can be a larger minor arc (e.g., larger than the minor arc of the arc-shaped heating coil 112 or 115) of the circle having the radius of curvature. In other cases, the larger arc can form a major arc of the circle having the same radius of curvature as each of the arc-shaped heating coils 112 and 115. The hinge 118 can allow the heating coils 112 and 115 to be pivoted so that the arc-shaped heating assemblies 103A-103E can open as well as close or clamp into proper position around a tank, pipe, or other object.

The articulation assembly 121 can be permanently or detachably connected to the arc-shaped heating coil 112, the arc-shaped heating coil 115, and the hinge 118. Where the articulation assembly 121 is detachably connected to the arc-shaped heating coil 112, the arc-shaped heating coil 115, and the hinge 118, this can allow a single articulation assembly 121 to temporarily or permanently attach the arc-shaped heating assembly 103A partially around a pipe, tank, or other object, retrieve another arc-shaped heating coil, attach it to the around a pipe, tank, or other object, and so on.

The arc-shaped heating coil 112 can be a serpentine heating coil, and the arc-shaped coil sections or conductors can be parallel laterally, as shown in FIG. 1B. In other words, the coil sections can be parallel laterally, orthogonal to the radius of curvature, as if formed around a cylindrical shape having the radius of curvature. A serpentine coil can be a coil that snakes back and forth. Accordingly, a first coil section adjacent to a second coil section and a third coil section can be electrically connected to the second coil section at a first end of the first coil section and to the third coil section at a second, opposite end. In some cases, the coil sections are actually a continuous conductor or coil that is bent to form the serpentine shape, and in other situations the sections are electrically connected using curved or any shape connection to form the serpentine heating coil. Likewise, the arc-shaped heating coil 115 can be a serpentine heating coil.

In other cases, the arc-shaped heating coil 112 and the arc-shaped heating coil 115 can be serpentine heating coils that include a number of straight sections that are arranged along a curve with the radius of curvature and extend laterally, orthogonal to the radius of curvature. In other words, if attached partially surrounding a pipe, each straight coil section would run along the length of the pipe, or orthogonal to the radius of curvature, and would be arranged so that the straight sections are arranged parallel to one another to form a curve around the pipe.

In other cases, the arc-shaped heating coil 112 and the arc-shaped heating coil 115 can each have a spiral shape, for example, when laid flat and viewed. The spiral shape as a whole can be curved with the radius of curvature, as if bent around a cylinder, pipe, or tube having the radius of curvature. The spiral shape can be a square spiral shape. In this case, curved coil sections that are curved with the radius of curvature can be connected by straight coil sections that are orthogonal to the radius of curvature.

FIG. 2 illustrates an arc-shaped heating assembly 200 and additional arc-shaped heating assemblies that are attached partially surrounding a cylindrical object 201 such as a tank or a pipe. The arc-shaped heating assembly 200 can include an arc-shaped heating coil 203 and an arc-shaped heating coil 206, each of which is connected to a connector 209.

The arc-shaped heating coil 203 can have a radius of curvature or substantially continuous or uniform curve. The arc-shaped heating coil 203 can include a number of arc-shaped conductors that are curved with the radius of curvature. A respective arc-shaped conductor of the arc-shaped heating coil 203 can have a shape of a first minor arc of a circle having the same radius of curvature. That is, the arc-shaped heating coil 203 can have a cross section or side view in the form of an arc that is less than half of the circle having the radius of curvature.

The arc-shaped heating coil 206 can also have a substantially continuous or uniform curve. In some examples, a radius of curvature of the arc-shaped heating coil 206 can be a same radius of curvature as that of the arc-shaped heating coil 203. The arc-shaped heating coil 206 can include a number of arc-shaped conductors that are curved with the radius of curvature. A respective arc-shaped conductor of the arc-shaped heating coil 206 can have a shape of a first minor arc of a circle having the same radius of curvature. That is, the arc-shaped heating coil 206 can have a cross section or side view in the form of an arc that is less than half of the circle having the radius of curvature. Alternatively, instead of each having a radius of curvature, each coil can have a predetermined shape that is designed to fit around a particular shape of an object, and the hinge allows the coils to open and close about the particular shape of the object.

As the arc-shaped heating coil 203 and the arc-shaped heating coil 206 are positioned to partially surround a pipe, tank, or other object, a portion of the pipe, tank, or other object is not surrounded or interfered with. This can be helpful where a tank car sits on a bolster plate or bowl, or the tank car includes wheels for rail or road transport, the bottom of the tank is not interfered with. Likewise, where a pipeline or other pipe is supported by such a bolster, cradle, or ground, the bottom of the pipeline is not interfered with. In some cases, a pipeline could be supported from a side or suspended from above, and as the arc-shaped heating coil 203 and the arc-shaped heating coil 206 are positioned to partially surround the pipeline, the portion from which the pipeline is supported can be avoided while still surrounding a portion of the pipeline for heating.

The connector 209 can be attached to the arc-shaped heating coil 203 and the arc-shaped heating coil 206. The connector 209 can align the arc-shaped heating coil 203 and the arc-shaped heating coil 206 into a single arc shape with the same radius of curvature. The arc-shaped heating coil 206 can have a side view or cross sectional view that has the single arc shape. In some cases, the connector 209 can be used to permanently or semi-permanently affix the arc-shaped heating coil 203 and the arc-shaped heating coil 206 about an object 201. In one embodiment, the connector 209 can include tubes that accept each of the arc-shaped conductors of the arc-shaped heating coil 203 and each of the arc-shaped conductors of the arc-shaped heating coil 203. For example, the conductors or coil sections can be inserted into the respective tubes of the connector 209 so that they are aligned.

In some cases, the connector 209 can include electrical connections that cause the arc-shaped conductors of the arc-shaped heating coil 203 and the arc-shaped conductors of the arc-shaped heating coil 206 to be electrically connected into a single conducting path. In other cases, the connector 209 can allow the arc-shaped conductors of the arc-shaped heating coil 203 and the arc-shaped conductors of the arc-shaped heating coil 206 to be parallel conducting paths. In some cases, the connector 209 is a mechanical connector without any electrical connections. The arc-shaped heating coil 203 and the arc-shaped heating coil 206 can be individually connected to a power source through individual control circuits, or can be part of a same conducting path that is connected to the power source and a control circuit.

Much like described for the arc-shaped heating coils 112 and 115, the arc-shaped heating coil 203 can be serpentine heating coils that have a conducting path that snakes back and forth. For example, the arc-shaped heating coil 203 can be a serpentine heating coil, and the arc-shaped coil sections or conductors can be laterally parallel, as shown in FIG. 2. In other words, the coil sections can be parallel laterally and orthogonal to the radius of curvature, as if formed around a cylindrical shape having the radius of curvature of the coil. In one serpentine arrangement, a first coil section that is adjacent to a second coil section and a third coil section can be electrically connected to the second coil section at a first end of the first coil section and to the third coil section at a second, opposite end. In some cases, the coil sections are actually a continuous conductor or coil that is bent to form the serpentine shape, and in other situations the sections are electrically connected using curved or any shape connection to form the serpentine heating coil. Likewise, the arc-shaped heating coil 206 can be a serpentine heating coil.

In other cases, the arc-shaped heating coil 203 and the arc-shaped heating coil 206 can be serpentine heating coils that include a number of straight sections that are arranged parallel along a curve with the radius of curvature and extend laterally, orthogonal to the radius of curvature. In other words, if attached partially surrounding a pipe, each straight coil section would run along the length of the pipe, or orthogonal to the radius of curvature, and would be arranged so that the straight sections are arranged parallel to one another along a curve shape around the pipe.

In other cases, the arc-shaped heating coil 203 and the arc-shaped heating coil 206 can each have a spiral shape, for example, where viewed as laid flat. The spiral shape as a whole can be curved with the radius of curvature, as if bent around a cylinder, pipe, or tube having the radius of curvature. The spiral shape can be a square spiral shape. In this case, curved coil sections that are curved with the radius of curvature can be connected by straight coil sections that are orthogonal to the radius of curvature.

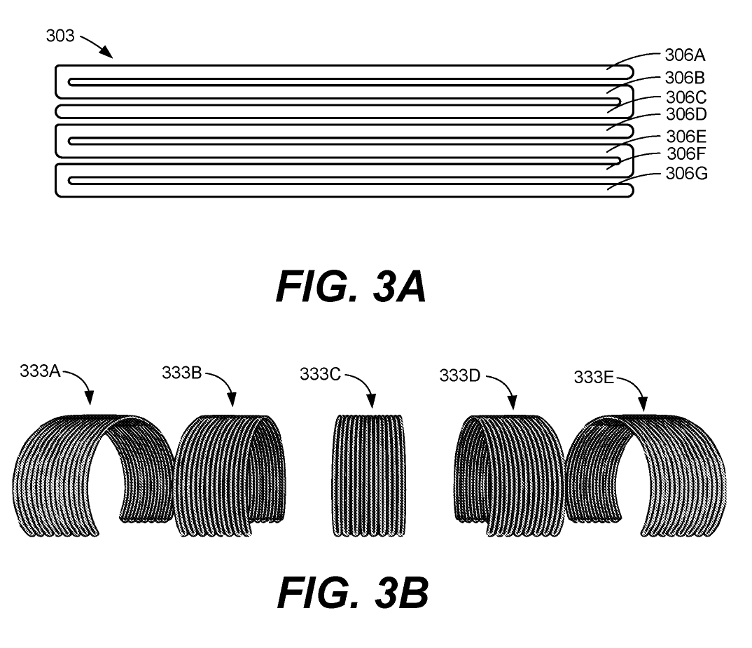

FIG. 3A shows one example of a serpentine shaped heating coil 303, that is shown flattened out. The heating coil 303 has coil sections 306A-306G in a serpentine pattern. For example, the coil section 306B can be adjacent to the coil section 306A and the coil section 306C. The coil section 306B can be electrically connected to the coil section 306A at a first end of the first coil section and to the coil section 306C at a second, opposite end. In some cases, the coil sections 306A-306G can be a continuous conductor or coil that is bent to form the serpentine pattern or shape. In other cases, the sections are electrically connected using connection at the ends, to form the serpentine heating coil 303. The connections can be curved, flat, or any other shape between the ends of the coil sections 306A-306G of the serpentine heating coil 303.

FIG. 3B shows arc-shaped heating coils 333A-333E. The arc-shaped heating coil 333A, which can be representative of each of the arc-shaped heating coils 333A-333E, can include a number of arc-shaped conductors that are curved with a radius of curvature of a cylinder or a circle. Each arc-shaped conductor of the arc-shaped heating coil 333A can be a major arc of the circle or cylinder having the radius of curvature. The arc-shaped conductors of the arc-shaped heating coil 333A can be arranged laterally, orthogonal to the radius of curvature and parallel to a centerline of the cylinder. The arc-shaped conductors of the arc-shaped heating coil 333A can be attached partially surrounding an object to be heated, such as a pipe or a tank. This arrangement can be for a more permanent attachment to a pipe, tank, or other object. In some cases, the arc-shaped conductors of the arc-shaped heating coil 333A can be part of a serpentine shape, as shown in FIG. 3A. Coil sections 306A-306G of FIG. 3A can be formed and bent around the object to be affixed to the object for heating. In the configuration shown in FIG. 3B, each of the coil sections 306A-306G of FIG. 3A could be bent with the radius of curvature, and arranged parallel laterally and orthogonal to the radius of curvature to form the arc-shaped heating coil 333A in FIG. 3B. In another example, each of the coil sections 306A-306G of FIG. 3A can remain straight, and they can be arranged parallel along a curve with the radius of curvature and extend laterally, orthogonal to the radius of curvature. In yet another example, the arc-shaped conductors of the arc-shaped heating coil 333A can be part of a spiral shape.

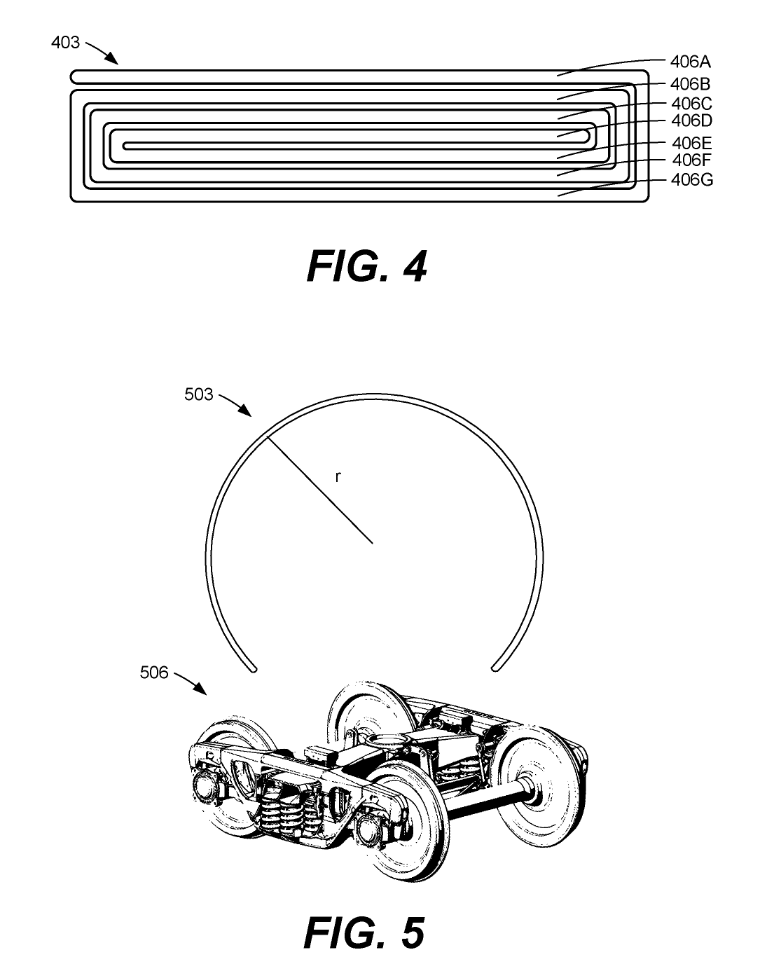

FIG. 4 shows a spiral shaped heating coil 403, that is shown flattened out. The heating coil 403 has coil sections 406A-406G in a square spiral pattern. The coil section 406A can be adjacent to the coil section 406B, the coil section 406B can be adjacent to the coil sections 406A and 406C, the coil section 406C can be adjacent to the coil sections 406B and 406D, and so on, and can be electrically connected in a spiral pattern or arrangement. In some cases, the coil sections 406A-406G can be a continuous conductor or coil that is bent to form the spiral pattern or shape. In other cases, the sections are electrically connected using curved or any shape connection at the ends, to form the spiral heating coil 403. The coil sections 406A-406G can each be curved with a same radius of curvature so that the spiral heating coil 403 is curved with the radius of curvature, for example, as seen from a side view or a cross sectional view.

FIG. 5 illustrates a side view of an arc-shaped heating coil 503, and a perspective view of a rail truck 506. The arc-shaped heating coil 503 can be a serpentine, spiral, or another heating coil that is bent into a shape of an arc with radius of curvature r, from a side view. The arc is a major arc of a circle having the radius of curvature r. The arc-shaped heating coil 503 could instead form a minor arc and could be used in connection with a hinge or connector and another arc-shaped heating coil. The rail truck 506 can carry a transportation tank on a support such as a bolster or cradle, and an arc-shaped heating coil such as the arc-shaped heating coil 503 or others discussed herein can be used without interfering with support systems.

As used herein, the term “approximate,” or “approximately” can refer to a distance or measure that differs by about 30% or less, about 25% or less, about 20% or less, about 15% or less, about 10% or less, or about 5% or less than the indicated distance or measure. The term “or less” can indicate a range that extends to 0% or to 0.01%. As used herein, the term “similar to,” for example in the phrase “diameter similar to,” or other such phrases can refer to diameter that differs by about 30% or less, about 25% or less, about 20% or less, about 15% or less, about 10% or less, or about 5% or less. The term “or less” can indicate a range that extends to 0% or to 0.01%.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. An apparatus comprising:
a first arc-shaped heating coil that is curved with a radius of curvature, the first arc-shaped heating coil being electrically connected to a power source;
a second arc-shaped heating coil that is curved with a same radius of curvature as the radius of curvature of the first arc-shaped heating coil, the second arc-shaped heating coil being electrically connected to the power source;
a hinge that is attached to the first arc-shaped heating coil and to the second arc-shaped heating coil; and
an articulation assembly connected to the first arc-shaped heating coil, the second arc-shaped heating coil, and the hinge, wherein the articulation assembly rotates the first arc-shaped heating coil and the second arc-shaped heating coil at the hinge to form a major arc.

2. The apparatus of claim 1, wherein the first arc-shaped heating coil and the second arc-shaped heating coil are inductive heating coils that produce an alternating magnetic field for inductive heating.

3. The apparatus of claim 1, wherein the first arc-shaped heating coil and the second arc-shaped heating coil are resistive heating coils.

4. The apparatus of claim 1, wherein the first arc-shaped heating coil is a serpentine heating coil comprising a plurality of arc-shaped sections that extend and curve with the radius of curvature and are parallel laterally, orthogonal to the radius of curvature.

5. The apparatus of claim 1, wherein the first arc-shaped heating coil is a serpentine heating coil comprising a plurality of straight sections that are arranged along a curve with the radius of curvature and extend laterally, orthogonal to the radius of curvature.

6. The apparatus of claim 1, wherein the first arc-shaped heating coil is a spiral heating coil that is curved with the radius of curvature.

7. The apparatus of claim 1, wherein the articulation assembly is detachably connected to the first arc-shaped heating coil, the second arc-shaped heating coil, and the hinge.

8. A heating coil comprising:
a plurality of arc-shaped conductors that is curved with a radius of curvature, the plurality of arc-shaped conductors being connected in a single pattern of the heating coil;
a respective arc-shaped conductor of the plurality of arc-shaped conductors having a shape of a major arc having the radius of curvature, each respective arc-shaped conductor of the plurality of arc-shaped conductors being arranged laterally parallel and orthogonal to the radius of curvature; and
wherein the major arc of each respective arc-shaped conductor of the plurality of arc-shaped conductors is partially surrounding an object to be heated.

9. The heating coil of claim 8, wherein the heating coil is an inductive heating coil that produces an alternating magnetic field for inductive heating.

10. The heating coil of claim 8, wherein the heating coil is a resistive heating coil.

11. The heating coil of claim 8, wherein the single pattern is a serpentine pattern, and the respective arc-shaped conductor of the plurality of arc-shaped conductors is electrically connected to an adjacent arc-shaped conductor of the plurality of arc-shaped conductors in the serpentine pattern.

12. The heating coil of claim 8, wherein the single pattern is a spiral pattern, and the plurality of arc-shaped conductors are electrically connected in the spiral pattern.

13. An apparatus comprising:
a first arc-shaped heating coil having a radius of curvature, the first arc-shaped heating coil comprising a first plurality of arc-shaped conductors that is curved with the radius of curvature, the first plurality of arc shaped conductors being arranged laterally parallel and orthogonal to the radius of curvature, a respective arc-shaped conductor of the first plurality of arc-shaped conductors having a shape of a first minor arc having the radius of curvature, the first arc-shaped heating coil being electrically connected to a power source;
a second arc-shaped heating coil having the radius of curvature, the second arc-shaped heating coil comprising a second plurality of arc-shaped conductors that are curved with the radius of curvature, the second plurality of arc shaped conductors being arranged laterally parallel and orthogonal to the radius of curvature, a respective arc-shaped conductor of the second plurality of arc-shaped conductors having a shape of a second minor arc having the radius of curvature, the second arc-shaped heating coil being electrically connected to the power source; and
a connector that is attached to the first arc-shaped heating coil and to the second arc-shaped heating coil and aligns the first arc-shaped heating coil and to the second arc-shaped heating coil into a single arc shape.

14. The apparatus of claim 13, wherein the single arc shape is a major arc having the radius of curvature.

15. The apparatus of claim 13, wherein the respective arc-shaped conductor of the first plurality of arc-shaped conductors is electrically connected to an adjacent arc-shaped conductor of the first plurality of arc-shaped conductors to form a serpentine pattern circuit.

16. The apparatus of claim 13, wherein the first plurality of arc-shaped conductors is electrically connected to form a spiral pattern circuit.
